(19) United States
(12) Patent Application Publication
(10) Pub. No.: US 2004/0184225 A1
(43) Pub. Date: Sep. 23, 2004

(54) Compact computer for embedded network system

(76) Inventor: Dodge Huang, Hsinchu (TW)

Correspondence Address: Malvern U. Griffin III, SUTHERLAND ASBILL & BRENNAN LLP, 999 Peachtree Street, NE, Atlanta, CA, 30309-3996, US

(21) Appl. No.: 10/390,418

(22) Filed: Mar. 17, 2003

(51) Int. Cl. G06F 1/16

(52) U.S. Cl. 361/683; 361/680

(57) ABSTRACT

The purpose of the present invention is to provide a compact computer for an embedded network system. The compact computer includes a main machine having plural functional devices for providing an embedded program system, a housing having an opening for containing the main machine and exposing the plural functional devices, and a covering piece for covering the opening of the housing, wherein the covering plate further includes plural protecting pieces respectively disposed alongside of the functional devices for preventing the functional devices from an electronic interference.

### FIELD OF THE INVENTION

The present invention is related to a thin client computer for an embedded network system, and more particularly to a thin client computer including a LCD type and a Box type and having an embedded device easy to be upgraded by a manufacturer and an end user.

### BACKGROUND OF THE INVENTION

In recent years there has been a great increase in the amount of computer technology that is involved in daily life. In today's world, computer technology is involved in many aspects of a person's day. Many devices being used today by consumers have a small computer inside of the device. These small computers come in varying sizes and degrees of sophistication. These small computers include everything from one microcontroller to a fully-functional complete computer system.

The small computers, (which can be rather large computers depending on the particular need which is being met by the computer), almost always have one or more processors at the heart of the computer. The processor(s) usually are interconnected to different external inputs and outputs and function to manage the particular device.

Computer technology is involved in many aspects of daily life. Many appliances, devices, etc., include one or more small computers. For example, refrigerators, telephones, typewriters, automobiles, vending machines, PDA, GPS, Set-Top-Box, embedded server, thin client, and many different types of industrial equipment all have small computers or processors inside of them. Computer software runs the processors of these computers and tells the processors what to do to carry out certain tasks.

These types of small computers that are a part of a device, appliance, tool, etc., are often referred to as embedded systems. The term “embedded system” usually refers to computer hardware and software that is part of a larger system. Embedded systems usually do not have typical input and output devices such as a keyboard, mouse, and/or monitor. Usually, at the heart of each embedded system is one or more processor(s). Typically the embedded systems used today with various appliances, devices, etc., do not have a lot of storage capability. As a result, the amount of data that can be stored on the embedded systems is limited. With only limited storage, an embedded system may not have as many features and capabilities as it could have if it had more available storage. Memory is often conserved in these embedded systems that monitor, control and otherwise use electronic devices.

Almost all desktop computer systems include memory management capabilities at, the processor level (hardware), firmware level (the software embedded into the hardware), and at the operating system level. However, in many embedded devices, these types of memory management capabilities are not available. Compared with all the desktop computer systems, the embedded computer provides more safety net and a database easy to be managed.

An embedded network system usually includes a main server and plural compact computers connected to the main server. A user utilizes several services of the main server via embedded programs of a compact computer (thin client). Meanwhile it is easy for the main server to manage the database of respective users of plural compact computers and application programs of plural compact computers. Plural compact computers connect to the Internet in safety via the main server. Compared with the server and PC clients of the prior network, the embedded network system saves a lot of cost of the hardware and the software. However in these types of environments, any program code is typically developed and loaded onto the embedded device by the manufacture before the device is shipped, after which software upgrades are rarely if ever even contemplated. When the user wants to upgrade the compact computer for the embedded network system, he has to displace the embedded device of the compact computer. Meanwhile the user has to take apart the case of the compact computer for exposing the embedded device, so as to upgrade the hardware of the compact computer. The upgrading procedure of the embedded device in the compact is very complex and it will take a lot of time to execute those processes.

Therefore, it is tried to rectify those drawbacks and provide a compact computer for an embedded network system by the present applicant, wherein the embedded device of the compact computer is easy to be replaced.

### SUMMARY OF THE INVENTION

It is therefore a primary objective of the present invention to provide an embedded computer including an embedded device, wherein the embedded device is easy to be replaced.

It is another objective of the present invention to provide a compact computer for an embedded network system, including a main machine having plural functional devices for providing an embedded program system, a housing having an opening for containing the main machine and exposing the plural functional devices, and a covering piece for covering the opening of the housing, wherein the covering plate further includes plural protecting pieces respectively disposed alongside of the functional devices for preventing the functional devices from an electronic interference.

Certainly, the plural functional embedded devices are plug-in memory devices.

Certainly, the plug-in memory devices can be ones selected from a group consisting of a Flash chip, an EPROM chip, a DDR chip and a RAM chip.

Preferably, the compact computer further includes a peripheral device connector.

Certainly, the peripheral device connector can be one selected from a group consisting of a power connector, a keyboard connector, a mouse connector, a USB connector, a network connector, a serial port connector and a parallel port connector.

Certainly, the covering piece can be a dismountable plate.

Preferably, the covering piece further includes plural through holes for passing plural screws therethrough to be fastened to the main machine.

Certainly, the compact computer can be further connected to a network.

Preferably, the compact computer directly utilizes a service of the network via the embedded program system.

Certainly, the network can be one selected from a group consisting of a local area network, an Internet and an Intranet.

Certainly, the compact computer can be further connected to a remote server.

Preferably, the compact computer directly utilizes a service of the remote server via the embedded program system.

Preferably, the compact computer further includes a LCD (Liquid Crystal Display) for displaying.

Certainly, the compact computer can be further connected to a monitor for displaying.

According to the present invention, the embedded computer can includes a main machine having a monitor and plural containing recesses, plural functional devices respectively disposed in the plural containing recesses and connected with the main machine for providing an embedded program system, and a dismountable cover disposed on the main machine for covering the plural containing recesses, wherein the dismountable cover further comprises plural protecting pieces respectively disposed alongside of the functional devices for preventing the functional devices from an electronic interference.

Certainly, the plural functional devices can be replaceable devices.

Certainly, the replaceable devices can be plug-in memory devices and are ones selected from a group consisting of a Flash chip, a EPROM chip, a DDR chip and a RAM chip.

Preferably, the embedded computer further includes a peripheral device connector.

Certainly, the peripheral device connector can be one selected from a group consisting of a power connector, a keyboard connector, a mouse connector, a USB connector, a network connector, a serial port connector and a parallel port connector.

Certainly, the dismountable cover can be a dismountable plate.

Preferably, the dismountable cover further includes plural through holes for passing plural screws therethrough to be fastened to the main machine.

Certainly, the embedded computer can be further connected to a network.

Preferably, the embedded computer directly utilizes a service of the network via the embedded program system.

Certainly, the network can be one selected from a group consisting of a local area network, an Internet and an Intranet.

Certainly, the embedded computer can be further connected to a remote server.

Preferably, the embedded computer directly utilizes a service of the remote server via the embedded program system.

According to another preferred embodiment of the present invention, the embedded computer includes a main machine having a containing recess, a replaceable device disposed in the containing recess for providing an embedded program, and a dismountable cover covering the containing recess of the main machine, wherein the dismountable cover further comprises a protecting piece disposed on the replaceable device for preventing the displaceable device from an electronic interference.

Preferably, the embedded computer of the present invention could includes a main machine having a displaceable device disposed thereon, a housing having an opening for containing the main machine and exposing the replaceable device, and a cover covering the opening for protecting the replaceable device.

Preferably, the cover further includes a protecting piece disposed on the replaceable device for preventing the replaceable device from an electronic interference.

The foregoing and other features and advantages of the present invention will be more clearly understood through the following descriptions with reference to the drawings, wherein:

### BRIEF DESCRIPTION OF THE DRAWING

FIG. 1 illustrates an embedded network system including the compact computer according to the present invention; and

FIG. 2 illustrates a structure of the compact computer according to the present invention.

### DETAILED DESCRIPTION OF THE PREFERRED EMBODIMENTS

The primary objective of the present invention is to provide an embedded computer including an embedded device, wherein the embedded device is easy to be displaced.

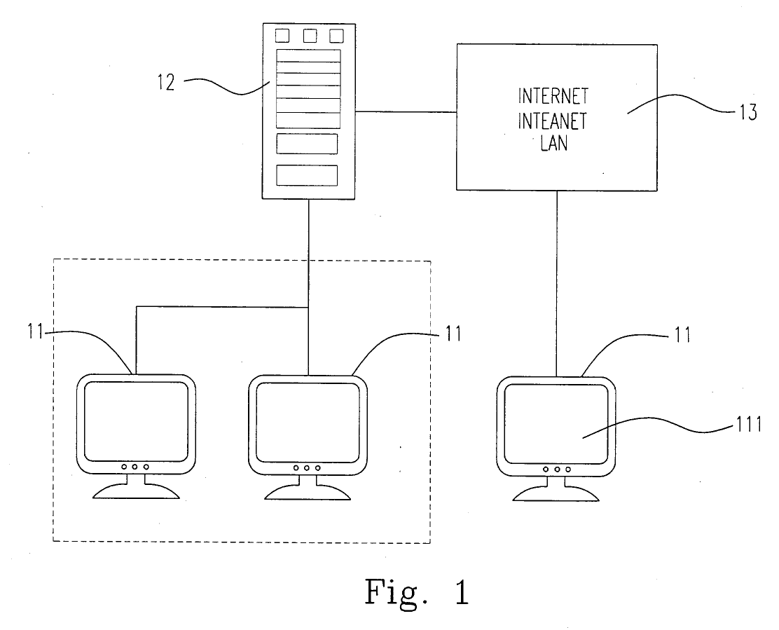

Please refer to FIG. 1. It illustrates an embedded network system including the compact computer according to the present invention. The compact computer 11 of the present invention has an embedded program included therein. When the compact computer 11 is initialized, the embedded program of the compact computer 11 is driven to connect to a network server 12 or to connect to a network system 13, so as to utilize the service of the network server 12 or the network system 13. In other words, the compact computer 11 of the present invention could apply the operating system, Windows CE/XP, and the transmission control protocol RDP 5.0/5.1 & ICA 6.0/63. Furthermore, the compact computer 11 of the present invention can also connect with Microsoft Windows 2000, Windows NT/TSE, or Citrix MetaFrame server 12 via RDP or ICA. Certainly, the compact computer can execute the application program of INTERNET or INTRANET on the main server 12. Moreover, the compact computer 11 of the present invention can include Microsoft IE browser for a user to Internet access. In fact, the compact computer could be in support of the multiterm simulation standard, several peripheral devices, several mainframes and the remote management tools. Accordingly, the memory devices of the compact computer can be upgraded in respect of the demand easily.

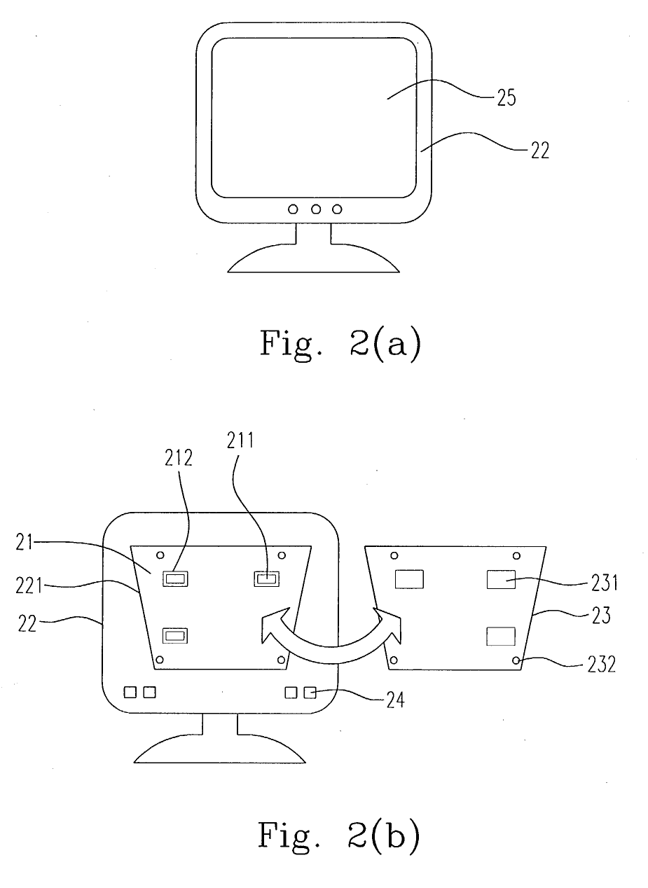

Please refer to FIG. 2. It illustrates a structure of the compact computer according to the present invention. The compact computer of the present invention includes a main machine 21 having plural functional devices 211 for providing an embedded program system, a housing 22 having an opening 221 for containing the main machine 21 and exposing the plural functional devices 211, and a covering piece 23 for covering the opening 221 of the housing 22, wherein the covering piece 23 further includes plural protecting pieces 231 respectively disposed alongside of the functional devices 211 for preventing the functional devices 211 from an electronic interference. Meanwhile, the plural functional devices 211 are plug-in memory devices and they can be ones selected from a group consisting of a Flash chip, a BIOS chip, and a RAM chip.

In the practical application, the compact computer of the present invention further includes a peripheral device connector 24, wherein the peripheral device connector 24 can be one selected from a group consisting of a power connector, a keyboard connector, a mouse connector, a USB connector, a network connector, a serial port connector and a parallel port connector. Furthermore, the covering piece 23 can be a dismountable plate and the covering piece 23 further includes plural through holes 232 for passing plural screws therethrough to be fastened to the main machine 21. The compact computer can be further connected to a network or directly utilize a service of the network via the embedded program system. The network can be one selected from a group consisting of a local area network, an Internet and an Intranet. Certainly, the compact computer can be further connected to a remote server and directly utilize a service of the remote server via the embedded program system. Moreover, the compact computer further includes a display monitor 25 for displaying or is connected to a monitor for displaying.

According to the present invention, the embedded computer can includes a main machine 21, 22 having a monitor 25 and plural containing recesses 211, plural functional devices 211 respectively disposed in the plural containing recesses 212 and connected with the main machine 21 for providing an embedded program system, and a dismountable cover 23 disposed on the main machine 21 for covering the plural containing recesses 212, wherein the dismountable cover 23 further comprises plural protecting pieces 231 respectively disposed alongside of the functional devices 211 for preventing the functional devices 211 from an electronic interference. Meanwhile, the plural functional devices 211 are plug-in memory devices and they can be ones selected from a group consisting of a Flash chip, a BIOS chip, and a RAM chip.

Similarly in the practical application, the compact computer of the present invention further includes a peripheral device connector 24, wherein the peripheral device connector 24 can be one selected from a group consisting of a power connector, a keyboard connector, a mouse connector, a USB connector, a network connector, a serial port connector and a parallel port connector. Furthermore, the covering piece 23 can be a dismountable plate and the covering piece 23 further includes plural through holes 232 for passing plural screws therethrough to be fastened to the main machine 21.

For a compact computer applied in the embedded network system, it has specific properties of fan-less, easy-to-setup, remote control and high-security. Accordingly, the invention is related to an embedded computer. It involves a dismountable cover for facilitating a user to upgrade the compact computer. Therefore, the compact computer could save a lot of cost and prevent the functional devices of the compact computer from an electronic interference. It is believed that the present invention is practicable for the industry.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A compact computer for an embedded network system, comprising:
a main machine having plural functional devices for providing an embedded program system;
a housing having an opening for containing said main machine and exposing said plural functional devices; and
a covering piece for covering said opening of said housing, wherein said covering piece further comprises plural protecting pieces respectively disposed alongside of said functional devices for preventing said functional devices from an electronic interference.

2. The compact computer according to claim 1, wherein said plural functional devices are plug-in memory devices.

3. The compact computer according to claim 2, wherein said plug-in memory devices are ones selected from a group consisting of a Flash chip, a EPROM chip, a DDR chip and a RAM chip.

4. The compact computer according to claim 1 further comprising a peripheral device connector.

5. The compact computer according to claim 4, wherein said peripheral device connector is one selected from a group consisting of a power connector, a keyboard connector, a mouse connector, a USB connector, a network connector, a serial port connector and a parallel port connector.

6. The compact computer according to claim 1, wherein said covering piece is a dismountable plate.

7. The compact computer according to claim 1, wherein said covering piece further comprises plural through holes for passing plural screws therethrough to be fastened to said main machine.

8. The compact computer according to claim 1, wherein said compact computer is further connected to a network.

9. The compact computer according to claim 8, wherein said compact computer directly utilizes a service of said network via said embedded program system.

10. The compact computer according to claim 8, wherein said network is one selected from a group consisting of a local area network, an Internet and an Intranet.

11. The compact computer according to claim 1, wherein said compact computer is further connected to a remote server.

12. The compact computer according to claim 11, wherein said compact computer directly utilizes a service of said remote server via said embedded program system.

13. The compact computer according to claim 1 further comprising a display monitor for displaying.

14. The compact computer according to claim 1, wherein said compact computer is further connected to a monitor for displaying.

15. An embedded computer comprising:
a main machine having a monitor and plural containing recesses;
plural functional devices respectively disposed in said plural containing recesses and connected with said main machine for providing an embedded program system; and
a dismountable cover disposed on said main machine for covering said plural containing recesses, wherein said dismountable cover further comprises plural protecting pieces respectively disposed alongside of said functional devices for preventing said functional devices from an electronic interference.

16. The embedded computer according to claim 15, wherein said plural functional devices are replaceable devices.

17. The embedded computer according to claim 16, wherein said replaceable devices are plug-in memory devices and are ones selected from a group consisting of a Flash chip, a EPROM chip, a DDR chip and a RAM chip.

18. The embedded computer according to claim 15 further comprising a peripheral device connector.

19. The embedded computer according to claim 18, wherein said peripheral device connector is one selected from a group consisting of a power connector, a keyboard connector, a mouse connector, a USB connector, a network connector, a serial port connector and a parallel port connector.

20. The embedded computer according to claim 15, wherein said dismountable cover is a dismountable plate.

21. The embedded computer according to claim 15, wherein said dismountable cover further comprises plural through holes for passing plural screws therethrough to be fastened to said main machine.

22. The embedded computer according to claim 15, wherein said embedded computer is further connected to a network.

23. The embedded computer according to claim 22, wherein said embedded computer directly utilizes a service of said network via said embedded program system.

24. The embedded computer according to claim 22, wherein said network is one selected from a group consisting of a local area network, an Internet and an Intranet.

25. The embedded computer according to claim 15, wherein said embedded computer is further connected to a remote server.

26. The embedded computer according to claim 25, wherein said embedded computer directly utilizes a service of said remote server via said embedded program system.

27. An embedded computer comprising:
a main machine having a containing recess;
a replaceable device disposed in said containing recess for providing an embedded program; and
a dismountable cover covering said containing recess of said main machine, wherein said dismountable cover further comprises a protecting piece disposed on said replaceable device for preventing said displaceable device from an electronic interference.

28. An embedded computer comprising:
a main machine having a displaceable device disposed thereon;
a housing having an opening for containing said main machine and exposing said replaceable device; and
a cover covering said opening for protecting said replaceable device.

29. The embedded computer according to claim 28, wherein said cover further comprises a protecting piece disposed on said replaceable device for preventing said replaceable device from an electronic interference.
